(19) United States
(12) Patent Application Publication
(10) Pub. No.: US 2025/0286748 A1
(43) Pub. Date: Sep. 11, 2025

(54) DELIVERY MODE OF TRAFFIC FOR TERMINAL DEVICES IN DIFFERENT RRC STATES

(71) Applicant: NOKIA SOLUTIONS AND NETWORKS OY, Espoo (FI)

(72) Inventors: Athul PRASAD, Naperville, IL (US); Mohamed Amin NASSAR, Munich (DE); David NAVRÁTIL, Helsinki (FI); Ugur Baran ELMALI, Munich (DE); Volker PAULI, Ansbach (DE); Naizheng ZHENG, Beijing (CN); David BHATOOLAUL, Swindon, Wiltshire (GB)

(21) Appl. No.: 18/858,558

(22) PCT Filed: Apr. 28, 2022
(86) PCT No.: PCT/CN2022/090074

§ 371 Date: Oct. 21, 2024

(51) Int. Cl. H04L 12/18; H04L 1/1812; H04W 4/06; H04W 72/30; H04W 76/27

(52) U.S. Cl. CPC H04L 12/189; H04L 1/1812; H04W 4/06; H04W 72/30; H04W 76/27

(57) ABSTRACT

Embodiments of the present disclosure relate to delivery mode of traffic for terminal devices in different RRC states. A first device determines, based on at least one criterion, to transmit multicast and/or broadcast traffic to a plurality of second devices in a first mode of delivery; and transmit the multicast and/or broadcast traffic to the plurality of second devices in the first mode of delivery by at least: transmitting, to a first subset of second devices among the plurality of second devices, a first downlink control information for the multicast and/or broadcast traffic using a first physical downlink control channel; transmitting, to a second subset of second devices among the plurality of second devices, a second downlink control information for the multicast and/or broadcast traffic using a second physical downlink control channel; and transmitting, to the plurality of second devices, the multicast and/or broadcast traffic using a physical downlink shared channel. In this way, it is possible to transmit the multicast and/or broadcast traffic from a first device to a plurality of second devices in a more radio efficient manner.

### FIELD

Embodiments of the present disclosure generally relate to the field of telecommunication and in particular, to a method, device, apparatus and computer readable storage medium for delivery mode of traffic for terminal devices in different Radio Resource Control (RRC) states.

### BACKGROUND

With development of communication technologies, several solutions have been proposed to provide efficient and reliable solutions for communication. For example, Multicast Service and Broadcast Service have been proposed to make it possible for efficient use of radio and network resources while transmitting audio and video content to a plurality of terminal devices. Multicast Service and Broadcast Service are both point-to-multipoint communication schemes where data packets are transmitted simultaneously from a single source to multiple destinations. The term “broadcast” refers to the ability to deliver traffic to all terminal devices regardless of the RRC states of the terminal devices. The term “multicast” refers to distribution of traffic among a specific group of terminal devices that are subscribed to those services. Currently, only terminal devices in a connected state can receive the traffic delivery in Multicast Service.

### SUMMARY

In general, example embodiments of the present disclosure provide a solution for delivery mode of traffic for terminal devices in different RRC states.

In a first aspect, there is provided a first device. The first device comprises at least one processor; and at least one memory including computer program code; wherein the at least one memory and the computer program code are configured to, with the at least one processor, cause the first device to: determine based on at least one criterion to transmit multicast and/or broadcast traffic to a plurality of second devices in a first mode of delivery; and transmit the multicast and/or broadcast traffic to the plurality of second devices in the first mode of delivery by at least: transmitting, to a first subset of second devices among the plurality of second devices, a first downlink control information for the multicast and/or broadcast traffic using a first physical downlink control channel; transmitting, to a second subset of second devices among the plurality of second devices, a second downlink control information for the multicast and/or broadcast traffic using a second physical downlink control channel; and transmitting, to the plurality of second devices, the multicast and/or broadcast traffic using a physical downlink shared channel.

In a second aspect, there is provided a second device. The second device comprises at least one processor; and at least one memory including computer program code; wherein the at least one memory and the computer program code are configured to, with the at least one processor, cause the second device to: receive, from a first device, downlink control information for multicast and/or broadcast traffic using a first physical downlink control channel; and receive, from the first device, the multicast and/or broadcast traffic using a physical downlink shared channel; wherein a third device receives, from the first device, a further downlink control information for the multicast and/or broadcast traffic using a second physical downlink control channel, and the multicast and/or broadcast traffic using the physical downlink shared channel.

In a third aspect, there is provided a method of communication. The method comprises determining, at a first device, based on at least one criterion to transmit multicast and/or broadcast traffic to a plurality of second devices in a first mode of delivery; and transmitting, at the first device and to the plurality of second devices, the multicast and/or broadcast traffic to the plurality of second devices in the first mode of delivery by at least: transmitting, at the first device and to a first subset of second devices among the plurality of second devices, a first downlink control information for the multicast and/or broadcast traffic using a first physical downlink control channel; transmitting, at the first device and to a second subset of second devices among the plurality of second devices, a second downlink control information for the multicast and/or broadcast traffic using a second physical downlink control channel; and transmitting, at the first device and to the plurality of second devices, the multicast and/or broadcast traffic using a physical downlink shared channel.

In a fourth aspect, there is provided a method of communication. The method comprises receiving, at a second device and from a first device, downlink control information for multicast and/or broadcast traffic using a first physical downlink control channel; and receiving, at the second device and from the first device, the multicast and/or broadcast traffic using a physical downlink shared channel; wherein: a further downlink control information for the multicast and/or broadcast traffic is received, at a third device and from the first device, using a second physical downlink control channel, and the multicast and/or broadcast traffic is received, at the third device and from the first device, using the physical downlink shared channel.

In a fifth aspect, there is provided an apparatus for communication. The apparatus comprises means for means for determining, at a first device, based on at least one criterion to transmit multicast and/or broadcast traffic to a plurality of second devices in a first mode of delivery; and means for transmitting, at the first device and to the plurality of second devices, the multicast and/or broadcast traffic to the plurality of second devices in the first mode of delivery by at least: transmitting, at the first device and to a first subset of second devices among the plurality of second devices, a first downlink control information for the multicast and/or broadcast traffic using a first physical downlink control channel; transmitting, at the first device and to a second subset of second devices among the plurality of second devices, a second downlink control information for the multicast and/or broadcast traffic using a second physical downlink control channel; and transmitting, at the first device and to the plurality of second devices, the multicast and/or broadcast traffic using a physical downlink shared channel.

In a sixth aspect, there is provided an apparatus for communication. The apparatus comprises means for receiving, at a second device and from a first device, downlink control information for multicast and/or broadcast traffic using a first physical downlink control channel; and means for receiving, at the second device and from the first device, the multicast and/or broadcast traffic using a physical downlink shared channel; wherein: a further downlink control information for the multicast and/or broadcast traffic is received, at a third device and from the first device, using a second physical downlink control channel, and the multicast and/or broadcast traffic is received, at the third device and from the first device, using the physical downlink shared channel.

In a seventh aspect, there is provided a non-transitory computer readable medium comprising program instructions for causing an apparatus to perform at least the method according to the above third aspect.

In an eighth aspect, there is provided a non-transitory computer readable medium comprising program instructions for causing an apparatus to perform at least the method according to the above fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates a diagram illustrating a process of communication according to some example embodiments of the present disclosure;

FIG. 3 illustrates a diagram illustrating a process of transmitting traffic in the first mode of delivery in terms of control/data channels according to some example embodiments of the present disclosure;

FIG. 4A illustrates a flowchart illustrating a first method of transmitting traffic according to example embodiments of the present disclosure;

FIG. 4B illustrates a flowchart illustrating a second method of transmitting traffic according to example embodiments of the present disclosure;

FIG. 4C illustrates a flowchart illustrating a third method of transmitting traffic according to example embodiments of the present disclosure;

FIG. 4D illustrates a flowchart illustrating a fourth method of transmitting traffic according to example embodiments of the present disclosure;

FIG. 4E illustrates a flowchart illustrating a fifth method of transmitting traffic according to example embodiments of the present disclosure;

FIG. 5 illustrates a flowchart illustrating a method of communication implemented at a first device according to example embodiments of the present disclosure;

FIG. 6 illustrates a flowchart illustrating a method of communication implemented at a second device according to example embodiments of the present disclosure;

FIG. 7 illustrates a simplified block diagram of a device that is suitable for implementing embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standard, such as fifth generation (5G) systems, fifth generation-advanced (5G-Advanced) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocol, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated and Access Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, or a combination of a plurality of the above, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

The term “multicast and/or broadcast traffic” as used herein implies traffic delivered to a group of users interested in receiving the traffic, and also implies data that is sent over the air and received by all users interested in receiving the traffic. In other words, the multicast and/or broadcast traffic as used herein may cover various point-to-multipoint communication schemes where data packets are transmitted simultaneously from a single source to multiple destinations. In the following description, the terms “traffic”, “multicast traffic”, “broadcast traffic”, and “multicast and/or broadcast traffic” may be used interchangeably.

Conventionally, physical downlink control channels (PDCCHs) are used to carry downlink (DL) or uplink (UL) data scheduling information, or grants, from a network device to one or more UEs. The scheduling information may include a resource allocation, a modulation and coding rate (or derived from transport block size), the identity of the intended UE or UEs, resources for sending uplink feedback, and other information. A PDCCH could be intended for a single UE, multiple UEs or all UEs in a cell, depending on the nature and content of the scheduled data. In broadcast communication scheme, a PDCCH is used to carry scheduling information for a physical downlink shared channel (PDSCH) that is intended to be received by all UEs in a cell, such as a PDCCH carrying system information about the network device, regardless of the RRC states of the UEs. In multicast communication scheme, a PDCCH is used to carry scheduling information for a PDSCH that is intended to be received by a group of UEs in a cell. In unicast communication scheme, a unicast PDCCH is used to carry scheduling information for a PDSCH that is intended to be received by only a single UE. There may be a situation where a plurality of UEs that are interested in receiving traffic comprise UEs in a connected state and UEs in an idle state and/or an inactive state. However, only UEs in a connected state can receive traffic delivered over a multicast; while all UEs may receive traffic delivered over a broadcast, but neither feedback capability nor link adaptation can be provided.

A new solution on delivery mode of traffic for terminal devices in different RRC states is needed. According to embodiments of the present disclosure, a first device determines, based on at least one criterion, to transmit multicast and/or broadcast traffic to a plurality of second devices in a first mode of delivery; and transmits the multicast and/or broadcast traffic to the plurality of second devices in the first mode of delivery by at least: transmitting, to a first subset of second devices among the plurality of second devices, a first downlink control information for the multicast and/or broadcast traffic using a first physical downlink control channel; transmitting, to a second subset of second devices among the plurality of second devices, a second downlink control information for the multicast and/or broadcast traffic using a second physical downlink control channel; and transmitting, to the plurality of second devices, the multicast and/or broadcast traffic using a physical downlink shared channel In this way, it is possible to transmit the multicast and/or broadcast traffic from a first device to a plurality of second devices in a more radio efficient manner. The above “at least” is to specify that there are at least two subsets of second devices with the first device processes. Should there be more than two subsets of second devices, the similar process will follow to other subsets of the second devices until “transmitting, to the plurality of second devices, the multicast and/or broadcast traffic using a physical downlink shared channel”.

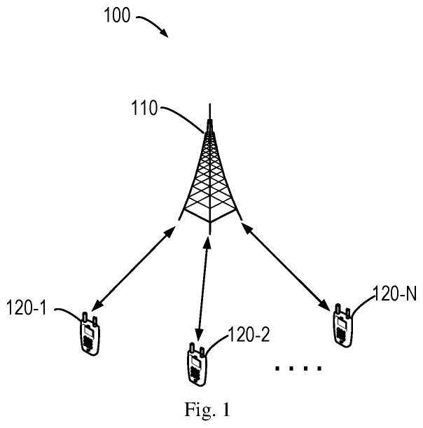

Principle and embodiments of the present disclosure will be described in detail below with reference to the accompanying drawings. Reference is first made to FIG. 1, which illustrates an example communication environment 100 in which embodiments of the present disclosure may be implemented. The communication environment 100, which is a part of a communication network, further comprises a first device 110 and second devices 120-1, 120-2, . . . , 120-N, which can be collectively referred to as “second device(s) 120”. The number N can be any suitable integer numbers.

The communication environment 100 may comprise any suitable number of devices and cells. In the communication environment 100, the first device 110 and the second device 120 can communicate data and control information to each other. In the case that the first device 110 is the network device and the second device 120 is the terminal device, a link from the first device 110 to the second device 120 is referred to as a downlink (DL), while a link from the second device 120 to the first device 110 is referred to as an uplink (UL).

It is to be understood that the communication environment 100 may include any suitable number of devices and networks adapted for implementing embodiments of the present disclosure.

As shown in FIG. 1, the first device 110 and the second device 120 may communicate with each other via a wireless communication channel. Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In some scenarios, a first subset of second devices in a connected state and a second subset of second devices in an idle state and/or an inactive state may be interested in receiving traffic from the first device 110.

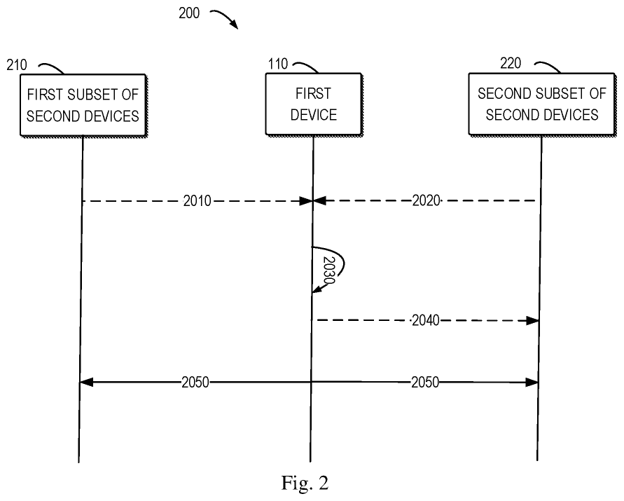

Reference is now made to FIG. 2, which illustrates a process 200 of communication according to some example embodiments of the present disclosure. For the purpose of discussion, the process 200 will be described with reference to FIG. 1. The process 200 may involve the first device 110 as illustrated in FIG. 1, the first subset of second devices 210 comprising one or more second devices 120 in a connected state and the second subset of second devices 220 comprising one or more second devices 120 in an idle state and/or an inactive state. It would be appreciated that although the process 200 has been described in the communication environment 100 of FIG. 1, this process may be likewise applied to other communication scenarios where different network devices are jointly deployed to provide respective serving cells.

In the process 200, the first device 110 may receive 2010, from the first subset of second devices 210 in a connected state, an indication that the first subset of second devices 210 request to receive multicast and/or broadcast traffic. The first device 110 may also receive 2020, from the second subset of second devices 220 in an idle state and/or an inactive state, an indication that the second subset of second devices 220 request to receive multicast and/or broadcast traffic. The first device 110 may determine 2030 the mode of delivery to be used for transmitting the multicast and/or broadcast traffic to the second devices 210 and 220 in response to receiving the above request indications. In alternative or in addition, the determination step 2030 may also be triggered in response to receiving, from the first subset of second devices 210, an indication that the first subset of second devices 210 receiving the multicast and/or broadcast traffic transitions from a connected state to an idle state or an inactive state. It will be appreciated that the signalling procedure in FIG. 2 is exemplary only. Although the receiving process 2010 and 2020 from the second devices 210 and 220 are illustrated as occurring simultaneously, the present invention is not limited in this regard. The receiving process 2010 may be earlier or later than the receiving process 2020.

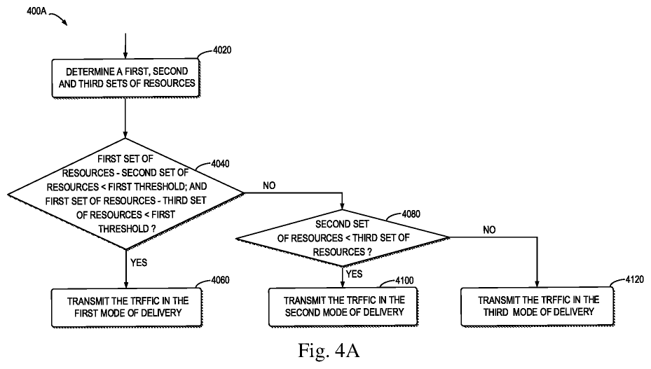

In an example embodiment, the first device 110 may determine whether the first device 110 is capable of supporting a first mode of delivery in response to receiving the trigger. In response to a determination that the first device 110 is capable of supporting a first mode of delivery, the first device 110 may determine 2030 the mode of delivery to be used among a first, second and third modes of delivery based on at least one criterion. In an example embodiment, the first device 110 may determine to transmit the multicast and/or broadcast traffic to the first and second subsets of second devices in the first mode of delivery if the first subset of second devices 210 requires to receive the multicast and/or broadcast traffic with a higher reliability than the second subset of second devices 220. Other example embodiments of the determination step 2030 will be described in detail below with references to FIGS. 4A-4E.

The first device 110 may simultaneously transmit 2050 the multicast and/or broadcast traffic to the second devices 210 and 220 in the mode of delivery determined in the determination step 2030. In an example embodiment, the first device 110 may transmit the multicast and/or broadcast traffic to the second devices 210 and 220 in the first mode of delivery in response to determining based on at least one criterion to transmit the multicast and/or broadcast traffic to the second devices 210 and 220 in the first mode of delivery.

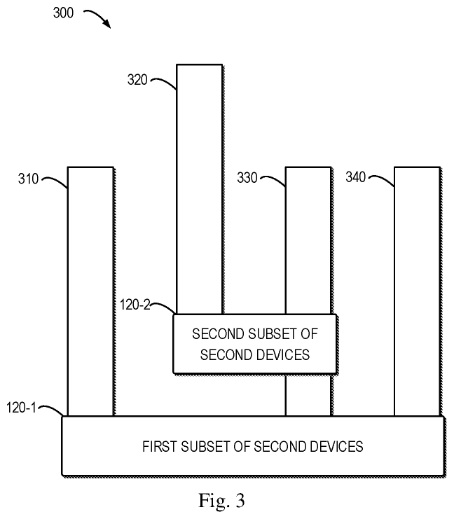

Reference is now made to FIG. 3, which illustrates a diagram illustrating a process 300 of transmitting traffic in the first mode of delivery in terms of control/data channels according to some example embodiments of the present disclosure. For the purpose of discussion, the process 300 will be described with reference to FIGS. 1 and 2.

In the first mode of delivery, the first device 110 may transmit, to the first subset of second devices 210, a first downlink control information (DCI) for the multicast and/or broadcast traffic using a first physical downlink control channel (PDCCH) 310; transmit, to the second subset of second devices 220, a second DCI for the multicast and/or broadcast traffic using a second PDCCH 320; and transmit, to the first and second subsets of second devices 210 and 220, the multicast and/or broadcast traffic using a physical downlink shared channel (PDSCH) 330. It should be understood that the “multicast and/or broadcast traffic” for the first subset of devices may include only multicast traffic, or only broadcast traffic, or both multicast traffic and broadcast traffic. Similarly, the “multicast and/or broadcast traffic” for the second subset of devices may include only multicast traffic, or only broadcast traffic, or both multicast traffic and broadcast traffic. The above options may constitute nine combinations, all of which are within the scope of the present disclosure. The second subset of second devices 220 may use Multicast Control CHannel-Radio Network Temporary Identifier (MCCH-RNTI) and G-RNTI for Multicast Traffic CHannel (MTCH). The first and second subsets of second devices 210 and 220 have the same G-RNTI for MTCH and DCI, due to PDSCH Cyclic Redundancy Check (CRC) scrambling. In addition, the first device 110 may receive from the first subset of second devices 210, feedback information for a hybrid automatic repeat request scheme (HARQ). Link adaptation and retransmission for the traffic delivery may be performed based on the feedback information received from the first subset of second devices 210. In an example embodiment, the first device 110 may adapt a modulation and coding scheme (MCS) based on the feedback received from the first subset of second devices 210. In another example embodiment, the MCS may be fixed. For example the MCS may be fixed based on 85^{th} or 90^{th} percentile user. In this manner, the first device 110 utilizes two simultaneous DCIs with associated PDCCHs transmissions to inform both the first subset of second devices 210 and the second subset of second devices 220 about a single PDSCH transmission. The first subset of second devices 210 in the connected state may receive the multicast and/or broadcast traffic with a higher reliability and a higher resource efficient than the second subset of second devices 220 in the idle state or the inactive state. In this way, it is possible to transmit the multicast and/or broadcast traffic from a first device to a plurality of second devices in different RRC states in a reliable and resource efficient manner. The first subset of second devices 210 may be provided with higher Quality-of-Service (QoS) and reliability and the second subset of second devices 220 may receive the multicast and/or broadcast traffic while maintaining the idle/inactive state, thus conserving power consumption of the second subset of second devices 220. It should be understood that while throughout this specification the first subset of the second devices are described as being in a connected state and the second subset of the second devices are described as being in an idle state and/or an inactive state, the present disclosure is not so limited. For example, the second devices in the idle state and the second devices in the active state may be operated differently. Upon reading this disclosure, that of ordinary kill in the art will appreciate still additional alternative designs through the disclosed principles of the embodiments. In addition, if there are other states than the connected state, the idle state and the inactive state, it is also within the scope of the present disclosure for implementations with the second devices in these states. Although in the present disclosure, the provision of only two different DCIs is shown in the first delivery mode, more DCIs may be provided for second devices in more different RRC states.

Reference is now made back to FIG. 2 to explain about a process of transmitting traffic in the second and third mode of delivery. In the second mode of delivery, the first device 110 may transmit 2040, to the second subset of second devices 220, an indication to transition from the idle state or the inactive state to the connected state; and transmit 2050, to the first and second subsets of second devices 210 and 220, a DCI for the multicast and/or broadcast traffic using a PDCCH and the multicast and/or broadcast traffic using a PSDCH. The second mode of delivery may be based on RRC configuration parameters received including PDCCH-Config/PDCCH-Config-Multicast and PDSCH-Config/PDSCH-Config-Multicast.

In the third mode of delivery, the first device 110 may transmit, to all second devices 120, a DCI for the multicast and/or broadcast traffic using a PDCCH and the multicast and/or broadcast traffic using a PSDCH over broadcast. The RRC configuration parameters of the third mode of delivery may be based on PDCCH-ConfigCommon/PDCCH-Config-MTCH/PDCCH-Config-MCCH and PDSCH-ConfigCommon/PDSCH-Config-MTCH/PDSCH-Config-MCCH.

Reference is now made to FIG. 4A, which illustrates a first method 400A of transmitting traffic according to example embodiments of the present disclosure. For the purpose of discussion, the method 400A will be described from the perspective of the first device 110 with reference to FIGS. 1-3.

At block 4020, the first device 110 determines a first, second and third sets of resources required for transmitting multicast and/or broadcast traffic to the first and second subsets of second devices 210 and 220 in the first, second and third modes of delivery, respectively. In an example embodiment, the first device 110 may determine whether the first device 110 is capable of supporting the first mode of delivery in response to receiving a trigger from at least one of the plurality of second devices 120, and determine the first, second and third sets of resources in response to determining that the first device 110 is capable of supporting the first mode of delivery. In an example embodiment, the trigger may comprise at least one of an indication that the first and second subsets of second devices 210 and 220 request to receive the multicast and/or broadcast traffic and an indication that the first subset of second devices 210 receiving the multicast and/or broadcast traffic transitions from a connected state to an idle state or an inactive state.

In an example embodiment, the first device 110 may determine the first set of resources based on resources required for transmitting the first and second DCIs using the first PDCCH 310 and the second PDCCH 320 and resources required for supporting the MCS that provides a predetermined percentage (e.g. 95%) of coverage. In an example embodiment, the first device 110 may determine the first set of resources further based on resources related to receiving feedback from the first subset of second devices 210. In an example embodiment, the MCS may be adapted based on the feedback received from the first subset of second devices 210. In another example embodiment, the MCS may be fixed. In an example embodiment, the first device 110 may determine the first set of resources based on overhead for beam sweeping for transmission in the first mode of delivery.

In an example embodiment, the first device 110 may determine the second set of resources based on resources related to receiving feedback from the first and second subset of second devices 210 and 220 and resources required for supporting a MCS. In an example embodiment, the first device 110 may adapt the MCS based on HARQ feedback and/or channel state information (CSI) feedback from the first and second subset of second devices 210 and 220 receiving the multicast and/or broadcast traffic in the second mode of delivery. In another example embodiment, the MCS may be fixed. For example the MCS may be fixed based on 85^{th} or 90^{th} percentile user. In an example embodiment, the first device 110 may determine the second set of resources based on overhead for beam sweeping for transmission in the second mode of delivery.

In an example embodiment, the first device 110 may determine the third set of resources based on resources for supporting a MCS that provides a predetermined percentage of coverage. For example, the first device 110 may be pre-configured with MCS requirements for 95% coverage in the third mode of delivery. In an example embodiment, the first device 110 may determine the third set of resources based on overhead for beam sweeping for transmission in the third mode of delivery.

At block 4040, the first device 110 determine whether both a first difference between the first set of resources and the second set of resources and a second difference between the first set of resources and the third set of resources are smaller than a first threshold.

At block 4060, in response to determining that both the first difference and the second difference are smaller than the first threshold, the first device 110 transmits the multicast and/or broadcast traffic to the first and second subsets of second devices 210 and 220 in the first mode of delivery.

At block 4080, in response to determining that at least one of the first difference and the second difference exceeds the first threshold, the first device 110 determines whether the second set of resources is smaller than the third set of resources.

At block 4100, in response to determining that the second set of resources is smaller than the third set of resources, the first device 110 transmits the multicast and/or broadcast traffic to the first and second subsets of second devices 210 and 220 in the second mode of delivery.

At block 4120, in response to determining that the second set of resources is larger than the third set of resources, the first device 110 transmits the multicast and/or broadcast traffic to the first and second subsets of second devices 210 and 220 in the third mode of delivery.

FIG. 4B illustrates a second method 400B of transmitting traffic according to example embodiments of the present disclosure.

At block 4220, the first device 110 determines whether the plurality of second devices 120 requesting to receive the multicast and/or broadcast traffic are spatially collocated or uniformly distributed.

At block 4240, in response to determining that the plurality of second devices 120 requesting to receive the multicast and/or broadcast traffic are spatially collocated, the first device 110 transmits the multicast and/or broadcast traffic to the plurality of second devices 120 in the second mode of delivery.

In response to determining that the plurality of second devices 120 requesting to receive the multicast and/or broadcast traffic are uniformly distributed, the process of method 400B turns to block 4020 in FIG. 4A.

It should be understood that the term “uniformly distributed” herein is not limited to an absolutely homogeneous distribution, but refers to that the devices are dispersed with respect to the devices being “spatially collocated”. It will be appreciated that when the geographical location distribution of the second device 120 is spatially collocated, less resources will be required to use to the second mode of delivery.

FIG. 4C illustrates a third method 400C of transmitting traffic according to example embodiments of the present disclosure.

At block 4420, the first device 110 determines whether the number of the first subset of second devices 210 requesting to receive the multicast and/or broadcast traffic is below a second threshold.

At block 4440, in response to determining that the number of the first subset of second devices 210 requesting to receive the multicast and/or broadcast traffic is below the second threshold, the first device 110 transmits the multicast and/or broadcast traffic to the plurality of second devices 120 in the second mode of delivery.

In response to determining that the number of the first subset of second devices 210 requesting to receive the multicast and/or broadcast traffic exceeds the second threshold, the process of method 400C turns to block 4020 in FIG. 4A.

FIG. 4D illustrates a fourth method 400D of transmitting traffic according to example embodiments of the present disclosure;

At block 4620, the first device 110 determines whether the number of the second devices 120 requesting to receive the multicast and/or broadcast traffic is below a third threshold.

At block 4640, in response to determining that the number of the second devices 120 requesting to receive the multicast and/or broadcast traffic is below the third threshold, the first device 110 transmits the multicast and/or broadcast traffic to the plurality of second devices 120 in the second mode of delivery.

In response to determining that the number of the second devices 120 requesting to receive the multicast and/or broadcast traffic exceeds the third threshold, the process of method 400D turns to block 4020 in FIG. 4A.

FIG. 4E illustrates a fifth method 400E of transmitting traffic according to example embodiments of the present disclosure.

At block 4820, the first device 110 determines whether the number of the second devices 120 requesting to receive the multicast and/or broadcast traffic exceeds a fourth threshold.

At block 4840, in response to determining that the number of the second devices 120 requesting to receive the multicast and/or broadcast traffic exceeds the fourth threshold, the first device 110 transmits the multicast and/or broadcast traffic to the plurality of second devices 120 in the third mode of delivery.

In response to determining that the number of the second devices 120 requesting to receive the multicast and/or broadcast traffic is below the fourth threshold, the process of method 400E turns to block 4020 in FIG. 4A.

It should be understood that the example embodiment in FIGS. 4A-4E merely provides example criterions for determining which mode of delivery to be used for delivering the multicast and/or broadcast traffic to a plurality of second devices in different states, without suggesting any limitation as to the scope of the disclosure. The first device may determine the mode of delivery to be used based on at least one of the criterions including the above example criterions and other criterions based on e.g., content to be transmitted, the capability of terminal devices, the throughput requirements, the requirements of sharing resources with other users, reliability requirements, latency requirements, etc. The first device may be pre-configured with threshold values for the at least one criterion using an Operation Administration and Maintenance (OAM).

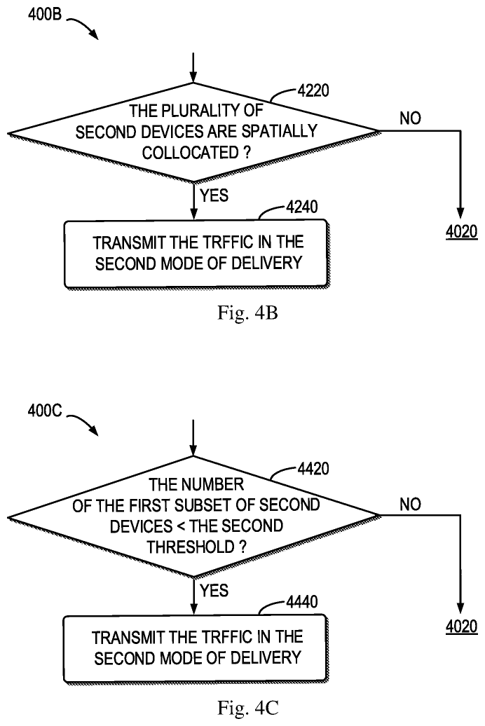

FIG. 5 shows a flowchart of an example method 500 implemented at a first device in accordance with some example embodiments of the present disclosure. For the purpose of discussion, the method 500 will be described from the perspective of the first device 110 with reference to FIG. 1.

At block 520, the first device 110 determines based on at least one criterion to transmit multicast and/or broadcast traffic to a plurality of second devices in a first mode of delivery.

At block 540, the first device 110 transmits the multicast and/or broadcast traffic to the plurality of second devices in the first mode of delivery by at least: transmitting, to a first subset of second devices among the plurality of second devices, a first downlink control information for the multicast and/or broadcast traffic using a first physical downlink control channel; transmitting, to a second subset of second devices among the plurality of second devices, a second downlink control information for the multicast and/or broadcast traffic using a second physical downlink control channel; and transmitting, to the plurality of second devices, the multicast and/or broadcast traffic using a physical downlink shared channel. The above “at least” is to specify that there are at least two subsets of second devices with the first device processes. Should there be more than two subsets of second devices, the similar process will follow to other subsets of the second devices until “transmitting, to the plurality of second devices, the multicast and/or broadcast traffic using a physical downlink shared channel”.

In some example embodiments, the first device 110 determines a first set of resources required for transmitting multicast and/or broadcast traffic to the plurality of second devices in the first mode of delivery, a second set of resources required for transmitting the multicast and/or broadcast traffic to the plurality of second devices in a second mode of delivery and a third set of resources required for transmitting the multicast and/or broadcast traffic to the plurality of second devices in a third mode of delivery; and in accordance with a determination that a first difference between the first set of resources and the second set of resources and a second difference between the first set of resources and the third set of resources are smaller than a first threshold, determines to transmit the multicast and/or broadcast traffic to the plurality of second devices in the first mode of delivery.

In some example embodiments, the first device 110 determines to transmit the multicast and/or broadcast traffic to the plurality of second devices in the first mode of delivery by determining that the first subset of second devices requires to receive the multicast and/or broadcast traffic with a higher reliability than the second subset of second devices.

In some example embodiments, the first device 110 is further caused to transmit the multicast and/or broadcast traffic to the plurality of second devices in the first mode of delivery by receiving, from the first subset of second devices, feedback information for a HARQ.

In some example embodiments, the first device 110 is further caused to in accordance with a determination that at least one of the first difference and the second difference exceeds the first threshold, determine whether the second set of resources is smaller than the third set of resources; and in accordance with a determination that the second set of resources is smaller than the third set of resources, transmit the multicast and/or broadcast traffic to the plurality of second devices in the second mode of delivery; or in accordance with a determination that the second set of resources is larger than the third set of resources, transmit the multicast and/or broadcast traffic to the plurality of second devices in the third mode of delivery.

In some example embodiments, in the second mode of delivery, the first device 110 is caused to transmit, to the second subset of second devices, an indication to transition from an idle state or an inactive state to a connected state; transmit, to the plurality of second devices, a downlink control information for the multicast and/or broadcast traffic using a physical downlink control channel; and transmit, to the plurality of second devices, the multicast and/or broadcast traffic using a physical downlink shared channel.

In some example embodiments, in the third mode of delivery, the first device 110 is caused to transmit, to the plurality of second devices, a downlink control information for the multicast and/or broadcast traffic using a physical downlink control channel; and transmit, to the plurality of second devices, the multicast and/or broadcast traffic using a physical downlink shared channel.

In some example embodiments, the first device 110 is caused to determine the first set of resources based on resources required for transmitting the first and second downlink control information; and resources required for supporting a modulation and coding scheme (MCS) that provides a predetermined percentage of coverage.

In some example embodiments, the first device 110 is caused to determine the first set of resources based on resources related to receiving feedback from the first subset of second devices.

In some example embodiments, the MCS is adapted based on the feedback received from the first subset of second devices; or the MCS is fixed.

In some example embodiments, the first device 110 is caused to determine the first set of resources based on overhead for beam sweeping for transmission in the first mode of delivery.

In some example embodiments, the first device 110 is caused to determine the second set of resources based on: resources related to receiving feedback from the plurality of second devices; and resources required for supporting a MCS.

In some example embodiments, the MCS is adapted based on HARQ feedback and/or channel state information (CSI) feedback from the plurality of second devices receiving the multicast and/or broadcast traffic; or the MCS is fixed.

In some example embodiments, the first device 110 is caused to determine the second set of resources based on overhead for beam sweeping for transmission in the second mode of delivery.

In some example embodiments, the first device 110 is caused to determine the third set of resources based on resources for supporting a MCS that provides a predetermined percentage of coverage.

In some example embodiments, the first device 110 is caused to determine the third set of resources based on overhead for beam sweeping for transmission in the third mode of delivery.

In some example embodiments, the first device 110 is further caused to determine whether the plurality of second devices are spatially collocated or uniformly distributed; and in accordance with a determination that the plurality of second devices are spatially collocated, transmit the multicast and/or broadcast traffic to the plurality of second devices in the second mode of delivery. The first device 110 is caused to determine the first, second and third sets of resources in accordance with a determination that the plurality of second devices are uniformly distributed.

In some example embodiments, the first device 110 is further caused to receive, from the first subset of second devices, a request indicating that the first subset of second devices are interested in receiving the multicast and/or broadcast traffic; determine whether the number of the first subset of second devices is below a second threshold; and in accordance with a determination that the number of the first subset of second devices is below the second threshold, transmit the multicast and/or broadcast traffic to the plurality of second devices in the second mode of delivery. The first device 110 is caused to determine the first, second and third sets of resources in accordance with a determination that the number of the second subset of second devices exceeds the second threshold.

In some example embodiments, the first device 110 is further caused to receive, from the plurality of second devices, a request indicating that the plurality of second devices are interested in receiving the multicast and/or broadcast traffic; determine whether the number of the plurality of second devices is below a third threshold; and in accordance with a determination that the number of the plurality of second devices is below the third threshold, transmit the multicast and/or broadcast traffic to the plurality of second devices in the second mode of delivery. The first device 110 is caused to determine the first, second and third sets of resources in accordance with a determination that the number of the plurality of second devices exceeds the third threshold.

In some example embodiments, the first device 110 is further caused to receive, from the plurality of second devices, a request indicating that the plurality of second devices are interested in receiving the multicast and/or broadcast traffic; determine whether the number of the plurality of second devices exceeds a fourth threshold; and in accordance with a determination that the number of the plurality of second devices exceeds the fourth threshold, transmit the multicast and/or broadcast traffic to the plurality of second devices in the third mode of delivery. The first device 110 is caused to determine the first, second and third sets of resources in accordance with a determination that the number of the plurality of second devices is below the fourth threshold.

In some example embodiments, the first device 110 is further caused to determine whether the first device is capable of supporting the first mode of delivery in response to receiving a trigger from at least one of the plurality of second devices.

In some example embodiments, the trigger comprises at least one of: an indication that the plurality of second devices request to receive the multicast and/or broadcast traffic; or an indication that the first subset of second devices receiving the multicast and/or broadcast traffic transitions from a connected state to an idle state or an inactive state.

In some example embodiments, an apparatus capable of performing any of the method 500 (for example, the first devices 110) may comprise means for performing the respective steps of the method 500. The means may be implemented in any suitable form. For example, the means may be implemented in a circuitry or software module. The apparatus may be implemented as or included in the first device 110. In some example embodiments, the means may comprise at least one processor and at least one memory including computer program code. The at least one memory and computer program code are configured to, with the at least one processor, cause performance of the apparatus.

In some example embodiments, the apparatus comprises: means for determining, at a first device, based on at least one criterion to transmit multicast and/or broadcast traffic to a plurality of second devices in a first mode of delivery; and means for transmitting, at the first device and to the plurality of second devices, the multicast and/or broadcast traffic to the plurality of second devices in the first mode of delivery by at least: transmitting, at the first device and to a first subset of second devices among the plurality of second devices, a first downlink control information for the multicast and/or broadcast traffic using a first physical downlink control channel; transmitting, at the first device and to a second subset of second devices among the plurality of second devices, a second downlink control information for the multicast and/or broadcast traffic using a second physical downlink control channel; and transmitting, at the first device and to the plurality of second devices, the multicast and/or broadcast traffic using a physical downlink shared channel. The above “at least” is to specify that there are at least two subsets of second devices with the first device processes. Should there be more than two subsets of second devices, the similar process will follow to other subsets of the second devices until “transmitting, to the plurality of second devices, the multicast and/or broadcast traffic using a physical downlink shared channel”.

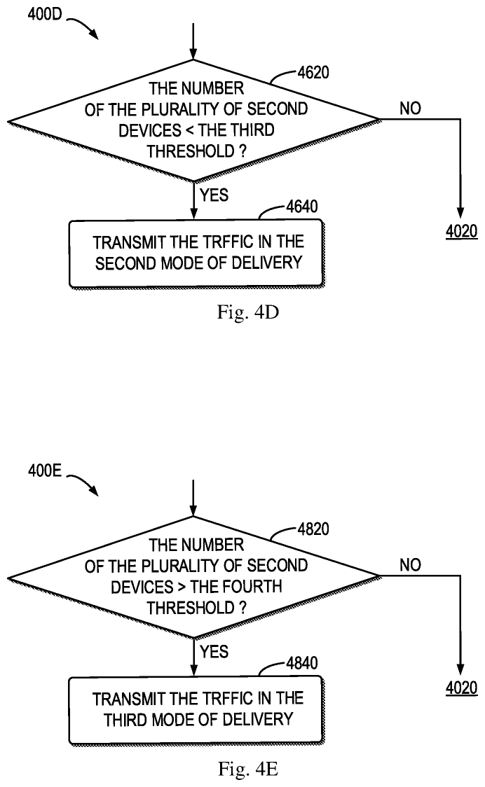

FIG. 6 shows a flowchart of an example method 600 implemented at a second device in accordance with some example embodiments of the present disclosure. For the purpose of discussion, the method 600 will be described from the perspective of the second device 120 with reference to FIG. 1.

At block 620, the second device 120 receives, from a first device, downlink control information for multicast and/or broadcast traffic using a first physical downlink control channel.

At block 640, the second device 120 receives, from the first device, the multicast and/or broadcast traffic using a physical downlink shared channel. A third device receives, from the first device, a further downlink control information for the multicast and/or broadcast traffic using a second physical downlink control channel, and the multicast and/or broadcast traffic using the physical downlink shared channel.

In some example embodiments, an apparatus capable of performing any of the method 600 (for example, the second device 120) may comprise means for performing the respective steps of the method 600. The means may be implemented in any suitable form. For example, the means may be implemented in a circuitry or software module. The apparatus may be implemented as or included in the second device 120. In some example embodiments, the means may comprise at least one processor and at least one memory including computer program code. The at least one memory and computer program code are configured to, with the at least one processor, cause performance of the apparatus.

In some example embodiments, the apparatus comprises: means for receiving, at a second device and from a first device, downlink control information for multicast and/or broadcast traffic using a first physical downlink control channel; and means for receiving, at the second device and from the first device, the multicast and/or broadcast traffic using a physical downlink shared channel; wherein: a further downlink control information for the multicast and/or broadcast traffic is received, at a third device and from the first device, using a second physical downlink control channel, and the multicast and/or broadcast traffic is received, at the third device and from the first device, using the physical downlink shared channel.

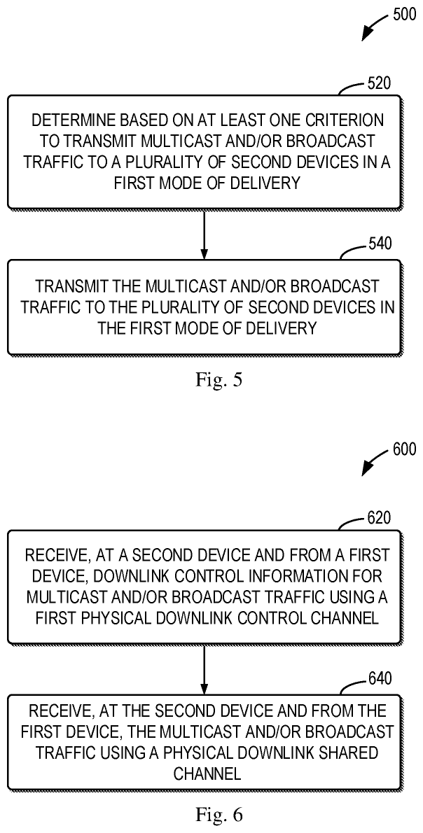

FIG. 7 is a simplified block diagram of a device 700 that is suitable for implementing embodiments of the present disclosure. The device 700 may be provided to implement the communication device, for example the first device 110 as shown in FIG. 1. As shown, the device 700 includes one or more processors 710, one or more memories 740 coupled to the processor 710, and one or more transmitters and/or receivers (TX/RX) 740 coupled to the processor 710.

The TX/RX 740 is for bidirectional communications. The TX/RX 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 1020. The processor 710 may perform any suitable actions and processing by loading the program 730 into the RAM 1020.

The embodiments of the present disclosure may be implemented by means of the program 730 so that the device 700 may perform any process of the disclosure as discussed with reference to FIGS. 2 to 6. The embodiments of the present disclosure may also be implemented by hardware or by a combination of software and hardware.

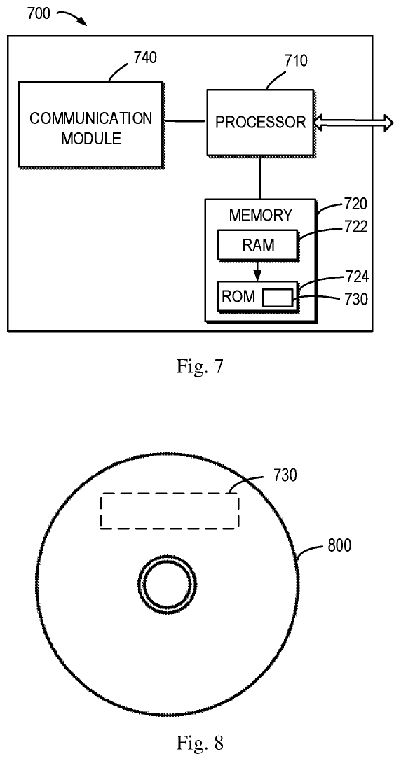

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 700 as described above with reference to FIGS. 2-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory including computer program code;
wherein the at least one memory and the computer program code are configured to, with the at least one processor, cause the first device to:
determine, based on at least one criterion, to transmit multicast and/or broadcast traffic to a plurality of second devices in a first mode of delivery; and
transmit the multicast and/or broadcast traffic to the plurality of second devices in the first mode of delivery by at least:
transmitting, to a first subset of second devices among the plurality of second devices, a first downlink control information for the multicast and/or broadcast traffic using a first physical downlink control channel;
transmitting, to a second subset of second devices among the plurality of second devices, a second downlink control information for the multicast and/or broadcast traffic using a second physical downlink control channel; and
transmitting, to the plurality of second devices, the multicast and/or broadcast traffic using a physical downlink shared channel.

2. The first device of claim 1, wherein determining based on at least one criterion to transmit multicast and/or broadcast traffic to a plurality of second devices in a first mode of delivery comprises:
determining a first set of resources required for transmitting multicast and/or broadcast traffic to the plurality of second devices in the first mode of delivery, a second set of resources required for transmitting the multicast and/or broadcast traffic to the plurality of second devices in a second mode of delivery and a third set of resources required for transmitting the multicast and/or broadcast traffic to the plurality of second devices in a third mode of delivery; and
in accordance with a determination that a first difference between the first set of resources and the second set of resources and a second difference between the first set of resources and the third set of resources are respectively smaller than a first threshold, determining to transmit the multicast and/or broadcast traffic to the plurality of second devices in the first mode of delivery.

3. The first device of claim 1, wherein determining based on at least one criterion to transmit multicast and/or broadcast traffic to a plurality of second devices in a first mode of delivery comprises:
determining to transmit the multicast and/or broadcast traffic to the plurality of second devices in the first mode of delivery by determining that the first subset of second devices requires to receive the multicast and/or broadcast traffic with a higher reliability than the second subset of second devices.

4. The first device of claim 1, wherein the first device is further caused to transmit the multicast and/or broadcast traffic to the plurality of second devices in the first mode of delivery by:
receiving, from the first subset of second devices, feedback information for a hybrid automatic repeat request scheme (HARQ).

5. The first device of claim 2, wherein the first device is further caused to:
in accordance with a determination that at least one of the first difference and the second difference exceeds the first threshold, determine whether the second set of resources is smaller than the third set of resources; and
in accordance with a determination that the second set of resources is smaller than the third set of resources, transmit the multicast and/or broadcast traffic to the plurality of second devices in the second mode of delivery by:
transmitting, to the second subset of second devices, an indication to transition from an idle state or an inactive state to a connected state;
transmitting, to the plurality of second devices, a downlink control information for the multicast and/or broadcast traffic using a physical downlink control channel; and
transmitting, to the plurality of second devices, the multicast and/or broadcast traffic using a physical downlink shared channel; or
in accordance with a determination that the second set of resources is larger than the third set of resources, transmit the multicast and/or broadcast traffic to the plurality of second devices in the third mode of delivery by:
transmitting, to the plurality of second devices, a downlink control information for the multicast and/or broadcast traffic using a physical downlink control channel; and
transmitting, to the plurality of second devices, the multicast and/or broadcast traffic using a physical downlink shared channel.

6. The first device of claim 2, wherein the first device is caused to determine the first set of resources by:
determining the first set of resources based on overhead for beam sweeping for transmission in the first mode of delivery; or
determining the first set of resources based on:
resources required for transmitting the first and second downlink control information;
resources required for supporting a modulation and coding scheme (MCS) that provides a predetermined percentage of coverage; and.
resources related to receiving feedback from the first subset of second devices;
wherein:
the MCS is adapted based on the feedback received from the first subset of second devices; or
the MCS is fixed.

7. The first device of claim 2, wherein the first device is caused to determine the second set of resources by:
determining the second set of resources based on overhead for beam sweeping for transmission in the second mode of delivery; or
determining the second set of resources based on:
resources related to receiving feedback from the plurality of second devices; and
resources required for supporting a MCS.
wherein:
the MCS is adapted based on HARQ feedback and/or channel state information (CSI) feedback from the plurality of second devices receiving the multicast and/or broadcast traffic; or
the MCS is fixed.

8. The first device of claim 2, wherein the first device is caused to determine the third set of resources by:
determining the third set of resources based on resources for supporting a MCS that provides a predetermined percentage of coverage; or
determining the third set of resources based on overhead for beam sweeping for transmission in the third mode of delivery.

9. The first device of claim 2, wherein the first device is further caused to:
determine whether the plurality of second devices are spatially collocated or uniformly distributed; and
in accordance with a determination that the plurality of second devices are spatially collocated, transmit the multicast and/or broadcast traffic to the plurality of second devices in the second mode of delivery; and
wherein the first device is caused to determine the first, second and third sets of resources by:
in accordance with a determination that the plurality of second devices are uniformly distributed, determining the first, second and third sets of resources.

10. The first device of claim 2, wherein the first device is further caused to:
receive, from the first subset of second devices, a request indicating that the first subset of second devices are interested in receiving the multicast and/or broadcast traffic;
determine whether the number of the first subset of second devices is below a second threshold; and
in accordance with a determination that the number of the first subset of second devices is below the second threshold, transmit the multicast and/or broadcast traffic to the plurality of second devices in the second mode of delivery; and
wherein the first device is caused to determine the first, second and third sets of resources by:
in accordance with a determination that the number of the second subset of second devices exceeds the second threshold, determining the first, second and third sets of resources.

11. The first device of claim 2, wherein the first device is further caused to:
receive, from the plurality of second devices, a request indicating that the plurality of second devices are interested in receiving the multicast and/or broadcast traffic;
determine whether the number of the plurality of second devices is below a third threshold; and
in accordance with a determination that the number of the plurality of second devices is below the third threshold, transmit the multicast and/or broadcast traffic to the plurality of second devices in the second mode of delivery; and
wherein the first device is caused to determine the first, second and third sets of resources by:
in accordance with a determination that the number of the plurality of second devices exceeds the third threshold, determining the first, second and third sets of resources.

12. The first device of claim 2, wherein the first device is further caused to:
receive, from the plurality of second devices, a request indicating that the plurality of second devices are interested in receiving the multicast and/or broadcast traffic;
determine whether the number of the plurality of second devices exceeds a fourth threshold; and
in accordance with a determination that the number of the plurality of second devices exceeds the fourth threshold, transmit the multicast and/or broadcast traffic to the plurality of second devices in the third mode of delivery; and
wherein the first device is caused to determine the first, second and third sets of resources by:
in accordance with a determination that the number of the plurality of second devices is below the fourth threshold, determining the first, second and third sets of resources.

13. The first device of claim 1, wherein the first device is further caused to:
in response to receiving a trigger from at least one of the plurality of second devices, determine whether the first device is capable of supporting the first mode of delivery.

14. The first device of claim 13, wherein the trigger comprises at least one of:
an indication that the plurality of second devices request to receive the multicast and/or broadcast traffic; or
an indication that the first subset of second devices receiving the multicast and/or broadcast traffic transitions from a connected state to an idle state or an inactive state.

15. A second device, comprising:
at least one processor; and
at least one memory including computer program code;
wherein the at least one memory and the computer program code are configured to, with the at least one processor, cause the second device to:
receive, from a first device, downlink control information for multicast and/or broadcast traffic using a first physical downlink control channel; and
receive, from the first device, the multicast and/or broadcast traffic using a physical downlink shared channel;
wherein a third device receives, from the first device, a further downlink control information for the multicast and/or broadcast traffic using a second physical downlink control channel, and the multicast and/or broadcast traffic using the physical downlink shared channel.

16. A method of communication, comprising:
determining, at a first device, based on at least one criterion to transmit multicast and/or broadcast traffic to a plurality of second devices in a first mode of delivery; and
transmitting, at the first device and to the plurality of second devices, the multicast and/or broadcast traffic to the plurality of second devices in the first mode of delivery by at least:
transmitting, at the first device and to a first subset of second devices among the plurality of second devices, a first downlink control information for the multicast and/or broadcast traffic using a first physical downlink control channel;
transmitting, at the first device and to a second subset of second devices among the plurality of second devices, a second downlink control information for the multicast and/or broadcast traffic using a second physical downlink control channel; and
transmitting, at the first device and to the plurality of second devices, the multicast and/or broadcast traffic using a physical downlink shared channel.

17. A method of communication, comprising:
receiving, at a second device and from a first device, downlink control information for multicast and/or broadcast traffic using a first physical downlink control channel; and
receiving, at the second device and from the first device, the multicast and/or broadcast traffic using a physical downlink shared channel;
wherein:
a further downlink control information for the multicast and/or broadcast traffic is received, at a third device and from the first device, using a second physical downlink control channel, and
the multicast and/or broadcast traffic is received, at the third device and from the first device, using the physical downlink shared channel.

18.-21. (canceled)
